(19) United States
(12) Patent Application Publication
(10) Pub. No.: US 2026/0046078 A1
(43) Pub. Date: Feb. 12, 2026

(54) DEVICES AND METHODS FOR EFFICIENT WIRELESS COMMUNICATION OVER LARGE BANDWIDTHS

(71) Applicant: HUAWEI TECHNOLOGIES CO., LTD., Shenzhen (CN)

(72) Inventors: Lutfi Zuhair Lutfi SAMARA, Munich (DE); Tommaso ZUGNO, Munich (DE); Mate BOBAN, Munich (DE); Malte SCHELLMANN, Munich (DE)

(21) Appl. No.: 19/366,878

(22) Filed: Oct. 23, 2025

Related U.S. Application Data
(63) Continuation of application No. PCT/EP2023/060602, filed on Apr. 24, 2023.

(51) Int. Cl. H04L 5/00

(52) U.S. Cl. CPC H04L 5/001; H04L 5/0053

(57) ABSTRACT

A transceiver device for wireless communication using carrier aggregation of a plurality of component carriers (CCs) distributed over an available bandwidth in an operational frequency range, each CC carrying a signal waveform. The transceiver device comprises a communication interface configured to transmit the plurality of CCs to a further transceiver device based on an adaptive communication configuration depending on a distance between the transceiver device and the further transceiver device. The adaptive communication configuration defines a CC bandwidth of the plurality of CCs and a number of the plurality of CCs.

### CROSS-REFERENCE TO RELATED APPLICATIONS

This application is a continuation of International Application No. PCT/EP2023/060602, filed on Apr. 24, 2023, the disclosure of which is hereby incorporated by reference in its entirety.

### TECHNICAL FIELD

The present disclosure relates to wireless communication technology. More specifically, the present disclosure relates to devices and methods for efficient wireless communication over large bandwidths, in particular at high frequencies, such as frequencies in the Terahertz frequency range.

### BACKGROUND

Wireless communication systems using large amount of bandwidth are typically subject to time-frequency synchronization errors. It is usually very challenging for traditional transceivers to communicate over single large bandwidths due to various hardware limitations. For example, when very large bandwidths are considered, the sampling time requirements may become tight, and the performance of an analog-to-digital converter (ADC) and a digital-to-analog converter (DAC) may become a bottleneck.

### SUMMARY

It is an objective of the present disclosure to provide devices and methods for a more efficient communication over large bandwidths, in particular at high frequencies, such as frequencies in the Terahertz frequency range.

The foregoing and other objectives are achieved by the subject matter of the independent claims. Further implementation forms are apparent from the dependent claims, the description and the figures.

According to a first aspect a transceiver device, in particular a UE, for wireless communication using carrier aggregation of a plurality of component carriers, CCs, distributed over an available bandwidth in an operational frequency range, each CC carrying a respective signal waveform, is provided. The transceiver device comprises a communication interface configured to transmit the plurality of CCs to a further transceiver device based on an adaptive communication configuration depending on a distance between the transceiver device and the further transceiver device. The adaptive communication configuration defines a CC bandwidth of the plurality of CCs and a number of the plurality of CCs. Thus, a device for efficient wireless communication over large bandwidths is provided. The device is particularly suitable for operating at high frequencies, such as Terahertz (THz) frequencies, i.e., frequencies in the 100 GHz to 10 THz band, where frequency resources are abundant. Indeed, the THz spectrum offers large chunks of unused bandwidth, which can be aggregated by the device according to the first aspect to utilize the whole available bandwidth.

In a further possible implementation form of the first aspect, the adaptive communication configuration further defines for each of the plurality of CCs a central CC frequency.

In a further possible implementation form of the first aspect, the communication interface is configured to transmit the plurality of CCs such that a respective guard band is arranged in the frequency domain between adjacent, i.e. neighbouring, CCs of the plurality of CCs.

In a further possible implementation form of the first aspect, the adaptive communication configuration defines a bandwidth of a plurality of guard bands that are located between adjacent CCs.

In a further possible implementation form of the first aspect, the transceiver device further comprises a processing circuitry configured to determine the adaptive communication configuration based on an estimate of the distance between the transceiver device and the further transceiver device.

In a further possible implementation form of the first aspect, the signal waveform is a multi-carrier signal waveform. In an implementation form, each CC may be carrying a respective Orthogonal Frequency-Division Multiplexing (OFDM) signal waveform.

In a further possible implementation form of the first aspect, the processing circuitry is further configured to determine the adaptive communication configuration based on the distance between the transceiver device and the further transceiver device and based on statistical information about the communication channel between the transceiver device and the further transceiver device and/or statistical information about a time and frequency synchronisation performance of the transceiver device.

In a further possible implementation form of the first aspect, the processing circuitry is further configured to implement a path loss model configured to provide a respective path loss estimate for a plurality of frequencies in the operational frequency range and for a plurality of distances between the transceiver device and the further transceiver device and the processing circuitry is further configured to determine the adaptive communication configuration using the path loss model.

In a further possible implementation form of the first aspect, the processing circuitry is configured to determine the adaptive communication configuration by maximizing a communication data rate for a plurality of candidate communication configurations.

In a further possible implementation form of the first aspect, the communication interface is configured to receive the adaptive communication configuration from the further transceiver device.

In a further possible implementation form of the first aspect, the transceiver device is a user equipment, UE, and the further transceiver device is a base station or a further UE.

According to a second aspect a method for wireless communication using carrier aggregation of a plurality of component carriers, CCs, distributed over an available bandwidth in an operational frequency range, each CC carrying a respective signal waveform, is provided. The method comprises: transmitting the plurality of CCs to a further transceiver device based on an adaptive communication configuration depending on a distance between the transceiver device and the further transceiver device, wherein the adaptive communication configuration defines a CC bandwidth of the plurality of CCs and a number of the plurality of CCs.

The method according to the second aspect of the present disclosure can be performed by the transceiver device according to the first aspect of the present disclosure. Thus, further features of the method according to the second aspect of the present disclosure result directly from the functionality of the transceiver device according to the first aspect of the present disclosure as well as its different implementation forms described above and below.

According to a third aspect a transceiver device, in particular a base station, for wireless communication using carrier aggregation of a plurality of component carriers, CCs, distributed over an available bandwidth in an operational frequency range, each CC carrying a respective signal waveform, is provided. The transceiver device comprises a processing circuitry configured to determine an adaptive communication configuration based on a distance between the transceiver device and a further transceiver device. The adaptive communication configuration defines a CC bandwidth of the plurality of CCs and a number of the plurality of CCs. The transceiver device further comprises a communication interface configured to transmit the adaptive communication configuration to the further transceiver device for transmission of the plurality of CCs by the further transceiver device to the transceiver device based on the adaptive communication configuration.

In a further possible implementation form of the third aspect, the adaptive communication configuration further defines for each of the plurality of CCs a central CC frequency.

In a further possible implementation form of the third aspect, the adaptive communication configuration defines a bandwidth of a plurality of guard bands that are located between adjacent CCs and to be used for transmission of the plurality of CCs by the further transceiver device to the transceiver device based on the adaptive communication configuration.

In a further possible implementation form of the third aspect, the processing circuitry is configured to determine the adaptive communication configuration based on an estimate of the distance between the transceiver device and the further transceiver device.

In a further possible implementation form of the third aspect, the signal waveform is a multi-carrier signal waveform. In an implementation form, each CC may be carrying a respective Orthogonal Frequency-Division Multiplexing (OFDM) signal waveform.

In a further possible implementation form of the third aspect, the processing circuitry is further configured to determine the adaptive communication configuration based on the distance between the transceiver device and the further transceiver device and based on statistical information about the communication channel between the transceiver device and the further transceiver device and/or statistical information about a time and frequency synchronisation performance of the further transceiver device.

In a further possible implementation form of the third aspect, the processing circuitry is further configured to implement a path loss model configured to provide a respective path loss estimate for a plurality of frequencies in the operational frequency range and for a plurality of distances between the transceiver device and the further transceiver device and the processing circuitry is further configured to determine the adaptive communication configuration using the path loss model.

In a further possible implementation form of the third aspect, the processing circuitry is configured to determine the adaptive communication configuration by maximizing a communication data rate for a plurality of candidate communication configurations.

In a further possible implementation form of the third aspect, the transceiver device is a base station or a user equipment, UE, and the further transceiver device is a further UE.

According to a fourth aspect a method for wireless communication using carrier aggregation of a plurality of component carriers, CCs, distributed over an available bandwidth in an operational frequency range, each CC carrying a respective signal waveform, is provided. The method comprises determining an adaptive communication configuration based on a distance between the transceiver device and a further transceiver device, wherein the adaptive communication configuration defines a CC bandwidth of the plurality of CCs and a number of the plurality of CCs. The method further comprises transmitting the adaptive communication configuration to the further transceiver device for transmission of the plurality of CCs by the further transceiver device to the transceiver device based on the adaptive communication configuration.

The method according to the fourth aspect of the present disclosure can be performed by the transceiver device according to the third aspect of the present disclosure. Thus, further features of the method according to the fourth aspect of the present disclosure result directly from the functionality of the transceiver device according to the third aspect of the present disclosure as well as its different implementation forms described above and below.

According to a fifth aspect a computer program product is provided, comprising a computer-readable storage medium for storing program code which causes a computer or a processor to perform the method according to the second aspect or the method according to the fourth aspect, when the program code is executed by the computer or the processor.

Details of one or more embodiments are set forth in the accompanying drawings and the description below. Other features, objects, and advantages will be apparent from the description, drawings, and claims.

### BRIEF DESCRIPTION OF THE DRAWINGS

In the following, embodiments of the present disclosure are described in more detail with reference to the attached figures and drawings, in which:

FIG. 1 shows a communication system comprising a first transceiver device according to an embodiment and a second transceiver device according to an embodiment;

FIG. 2a shows a diagram illustrating a component carrier (CC) allocation scheme in the THz band implemented by a transceiver device according to an embodiment;

FIG. 2b shows a graph illustrating an available bandwidth as a function of a varying distance between a first transceiver device according to an embodiment and a second transceiver device according to an embodiment;

FIG. 3 shows a signaling diagram illustrating a signaling procedure between a first transceiver device according to an embodiment and a second transceiver device according to an embodiment;

FIG. 4a shows a schematic diagram illustrating a first procedure of a first algorithm and a second procedure of a second algorithm implemented by the first transceiver device according to an embodiment;

FIG. 4b shows an exemplary pseudo code of the first algorithm of FIG. 4a according to a first main embodiment;

FIG. 4c shows an exemplary pseudo code of the second algorithm of FIG. 4a according to the first main embodiment;

FIG. 4d shows an exemplary pseudo code of a third algorithm implemented by the first transceiver device according to a second main embodiment;

FIG. 5a shows graphs illustrating an error vector magnitude versus a selected bandwidth;

FIG. 5b shows a graph illustrating the aggregate data rate (ADR) for different CC bandwidths for an exemplary transceiver distance of 200 meters;

FIG. 6 shows a flow diagram illustrating a method of operating a transceiver device according to an embodiment for wireless communication using carrier aggregation of a plurality of component carriers; and

FIG. 7 shows a flow diagram illustrating a method of operating a transceiver device according to a further embodiment for wireless communication using carrier aggregation of a plurality of component carriers.

In the following, identical reference signs refer to identical or at least functionally equivalent features.

### DETAILED DESCRIPTION OF THE EMBODIMENTS

In the following description, reference is made to the accompanying figures, which form part of the disclosure, and which show, by way of illustration, specific aspects of embodiments of the present disclosure or specific aspects in which embodiments of the present disclosure may be used. It is understood that embodiments of the present disclosure may be used in other aspects and comprise structural or logical changes not depicted in the figures. The following detailed description, therefore, is not to be taken in a limiting sense, and the scope of the present disclosure is defined by the appended claims.

For instance, it is to be understood that a disclosure in connection with a described method may also hold true for a corresponding device or system configured to perform the method and vice versa. For example, if one or a plurality of specific method steps are described, a corresponding device may include one or a plurality of units, e.g. functional units, to perform the described one or plurality of method steps (e.g. one unit performing the one or plurality of steps, or a plurality of units each performing one or more of the plurality of steps), even if such one or more units are not explicitly described or illustrated in the figures. On the other hand, for example, if a specific apparatus is described based on one or a plurality of units, e.g. functional units, a corresponding method may include one step to perform the functionality of the one or plurality of units (e.g. one step performing the functionality of the one or plurality of units, or a plurality of steps each performing the functionality of one or more of the plurality of units), even if such one or plurality of steps are not explicitly described or illustrated in the figures. Further, it is understood that the features of the various exemplary embodiments and/or aspects described herein may be combined with each other, unless specifically noted otherwise.

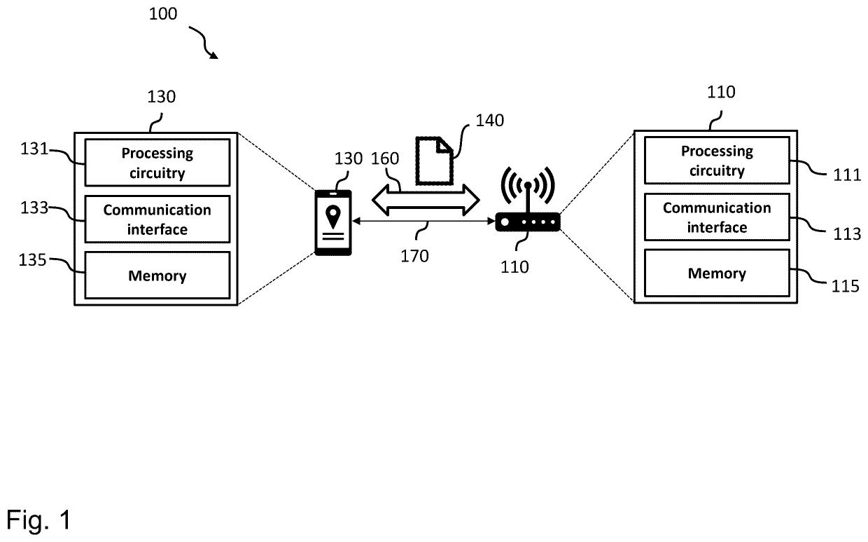

FIG. 1 shows a communication system 100 comprising a first transceiver device 110 according to an embodiment and a second transceiver device 130 according to an embodiment. The second transceiver device 130 may be a user equipment, UE, 130 and the first transceiver device 110 may be a base station 110 or a further UE 110. The communication system 100 may be a wireless communication network 100.

As illustrated in FIG. 1, the first transceiver device 110 comprises a processing circuitry 111 and a communication interface 113 for wirelessly communicating with the second transceiver device 130 via at least one communication channel 160. The processing circuitry 111 may be implemented in hardware and/or software and may comprise digital circuitry, or both analog and digital circuitry. Digital circuitry may comprise components such as application-specific integrated circuits (ASICs), field-programmable gate arrays (FPGAs), digital signal processors (DSPs), or general-purpose processors. The first transceiver device 110 may further comprise a memory 115 configured to store executable program code which, when executed by the processing circuitry 111, causes the first transceiver device 110 to perform the functions and methods described herein.

Likewise, the second transceiver device 130 may comprise a processing circuitry 131 and comprises a communication interface 133 for wirelessly communicating with the first transceiver device 110 via the at least one communication channel 160. The processing circuitry 131 may be implemented in hardware and/or software and may comprise digital circuitry, or both analog and digital circuitry. Digital circuitry may comprise components such as application-specific integrated circuits (ASICs), field-programmable gate arrays (FPGAs), digital signal processors (DSPs), or general-purpose processors. The second transceiver device 130 may further comprise a memory 135 memory configured to store executable program code which, when executed by the processing circuitry 131, causes the second transceiver device 130 to perform the functions and methods described herein.

As will be described in more detail below, the first transceiver device 110 is configured for wireless communication using carrier aggregation of a plurality of component carriers, CCs, distributed over an available bandwidth in an operational frequency range, each CC carrying a respective signal waveform. Likewise, the second transceiver device 130 is configured for wireless communication using carrier aggregation of the plurality of CCs distributed over the available bandwidth in the operational frequency range.

The processing circuitry 111 of the first transceiver device 110 is configured to determine an adaptive communication configuration 140 based on a distance 170 between the first transceiver device 110 and the second transceiver device 130. The adaptive communication configuration 140 defines a CC bandwidth of the plurality of CCs and a number of the plurality of CCs. The adaptive communication configuration 140 may further define for each of the plurality of CCs a central CC frequency.

The communication interface 113 of the first transceiver device 110 is configured to transmit the adaptive communication configuration 140 to the second transceiver device 130 for transmission of the plurality of CCs by the second transceiver device 130 to the first transceiver device 110 based on the adaptive communication configuration 140.

The communication interface 133 of the second transceiver device 130 is configured to transmit the plurality of CCs to the first transceiver device 110 based on the adaptive communication configuration 140 depending on the distance 170 between the second transceiver device 130 and the first transceiver device 110.

The communication interface 133 of the second transceiver device 130 may be configured to transmit the plurality of CCs such that a respective guard band is arranged in the frequency domain between adjacent, i.e. neighbouring, CCs of the plurality of CCs. The adaptive communication configuration 140 may further define a bandwidth of a plurality of guard bands that are located between adjacent CCs.

In the following, first transceiver device 110 and the second transceiver device 130 are described in more detail using the example of orthogonal frequency division multiplexing (OFDM) signal waveforms. As will be appreciated, embodiments disclosed herein are not limited to OFDM signal waveforms and can be applied to other types of waveforms.

Moreover, for exemplary purposes, the first transceiver device 110 is also referred to as a transceiver device B 110 and the second transceiver device 130 is also referred to as a transceiver device A 130 which communicate in the THz band. As will be appreciated, the embodiments disclosed herein are not limited to such a configuration and can comprise other configurations.

As described above and below, embodiments disclosed herein may solve the problem of maximizing the ADR (achievable data rate) of the (wireless) communication system 100 using large amount of bandwidth subject to time-frequency synchronization errors by leveraging adaptive orthogonal frequency division multiplexing (OFDM) numerology and carrier aggregation. In particular, since it is challenging for practical transceivers to communicate over single large bandwidths due to various hardware limitations, embodiments disclosed herein may be directed to the partitioning of the THz spectrum into several component carriers (CCs), guard bands and no transmission zones, where each CC carries the information bearing signal, guard bands serve to prevent inter-CC interference, and no transmission zones may be allocated to avoid excessive path loss. Unlike traditional approaches, the spectrum partitioning may be performed in a way such that the OFDM signal's bandwidth, i.e. the bandwidth of each CC, is tailored to consider the synchronization limitations of the receiver, i.e. the UE 130, which are critical in the case of using OFDM.

As will be described in more detail below, embodiments of the transceiver devices 110 and 130 disclosed herein are configured to determine the number of OFDM CCs to be deployed given an available bandwidth, the bandwidth for each of the OFDM CCs as well as the carrier frequencies for each of the OFDM CCs.

Embodiments disclosed herein may for example be directed to wireless communication systems 100 operating at Terahertz (THz) frequencies systems, i.e. communication systems 100 operating in 100 GHz-10 THz band) where frequency resources may be abundant. Indeed, the THz spectrum may offer large chunks of unused bandwidth, which can be aggregated to utilize the whole available bandwidth.

Embodiments disclosed herein may be directed to the use of several CCs to cover the available frequency range and reach a CC setup, i.e. the adaptive communication configuration 140, that maximizes the data rate. For each CC, OFDM may be leveraged to combat multipath. Multicarrier waveforms such as OFDM may be useful in combating frequency selectivity.

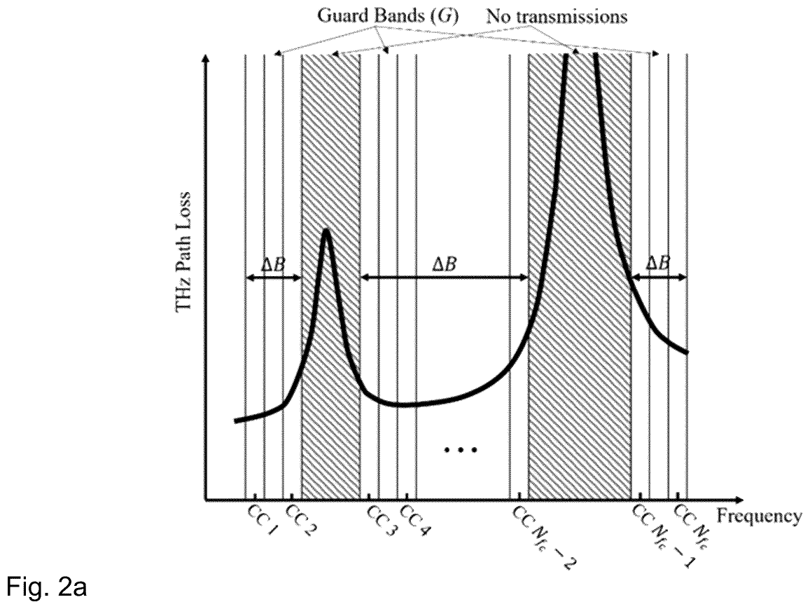

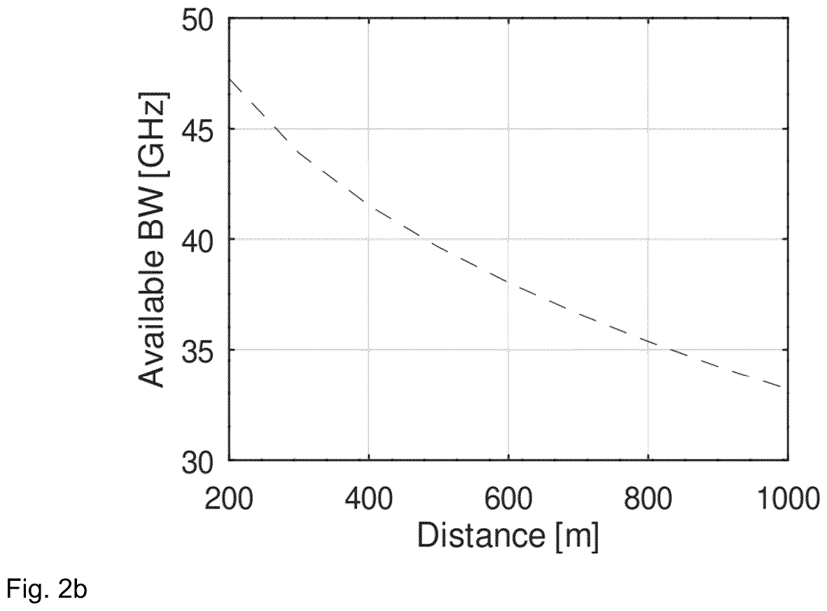

FIG. 2a shows a schematic diagram of a CC allocation scheme in the THz band, where the carrier frequency for each CC may be selected such that the spectrum chunks exhibiting excessive path loss peaks are avoided. Moreover, guard-bands may be inserted between adjacent CCs to prevent inter-CC interference. For a fixed CC bandwidth (CCB), the number of CCs may vary as the separation distance 170 between the first transceiver device 110 and the second transceiver device 130 is varied due to the change of the path loss peaks.

FIG. 2b shows the result of determining the available bandwidth as a function of a varying distance 170 between the first transceiver device 110 according to an embodiment and the second transceiver device 130 according to an embodiment. FIG. 2b shows an interdependency between the separation distance and path loss and a monotonic drop of the available bandwidth, mainly due to the widening of the span (in frequency) of the path loss peaks as the distance is increased. Hence, it can be concluded that the number of CCs may vary with varying distances 170.

As already described above, in the illustrative example of OFDM signal waveforms a three-part problem, i.e. (i) the number of OFDM CCs to be deployed given the varying distance 170; (ii) which OFDM CCB to use; and (iii) which carrier frequencies to be used for the OFDM CCs, may be solved with the aim of maximizing the overall data rate given that the receiver, i.e. the second transceiver device 130, is impaired with time and frequency synchronization errors.

To achieve this aim, embodiments disclosed herein provide a CC setup, i.e. the adaptive communication configuration 140, that may maximize the data rate resulting from the combination of varying the CCB through adaptive OFDM numerology, i.e. the adaptive communication configuration 140, and CC aggregation.

The BS 110 and the UE 130 may have the ability to adapt their OFDM numerologies, i.e. the adaptive communication configuration 140, and may be able to transmit and receive, respectively, simultaneously over several carriers. Also, the UE 130 may be able to aggregate the carriers over several frequency bands. In this context, carrier aggregation may be aimed at exploiting the available frequency resources to increase the achievable data rate, and the adaptive numerology, i.e. the adaptive communication configuration 140, is implemented by varying the subcarrier spacing while fixing the FFT size and may be aimed to combat the time-frequency synchronization errors through varying the CCB.

In particular, for a fixed FFT size, higher CCB (higher subcarrier spacing (SCS)) may imply higher sensitivity to time synchronization errors (TSE), while for a lower bandwidth (lower SCS) it may imply higher sensitivity to frequency synchronization errors (FSE). Therefore, for different UEs 130, each CCB may exhibit different error performance and hence may impact the communication quality. To ensure the mitigation of inter-CC interference, guard bands may be inserted by the BS 110 with a predefined value G.

Embodiments disclosed herein may be based on the exchange of several parameters between the second transceiver device 130, e.g. the UE 130 and the first transceiver device, e.g. the BS 110 that may be necessary to initiate the communications.

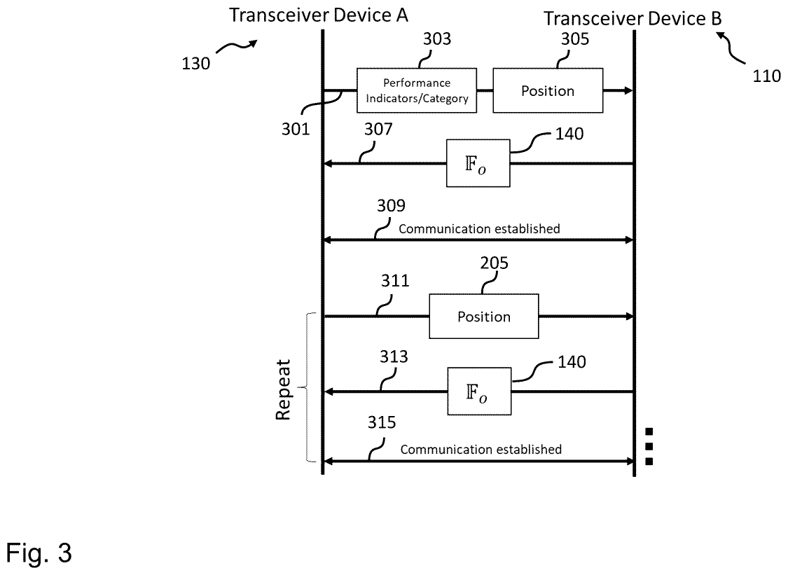

FIG. 3 shows a signaling diagram illustrating a signaling procedure between the first transceiver device 110 (referred to as Transceiver Device B in FIG. 3) according to an embodiment, e.g. the BS 110, and the second transceiver device 130 (referred to as Transceiver Device A in FIG. 3) according to an embodiment, e.g. the UE 130.

In step 301 of FIG. 3, the second transceiver device 130 may send performance indicator metrics that may quantify the capabilities of the second transceiver 130, e.g. the UE 130, to the first transceiver device 110, e.g. the BS 110. The capabilities in this context may quantify a) the time-frequency synchronization accuracy and/or b) the AWGN (additive white Gaussian noise) power of the second transceiver device 130. This information may be comprised in a performance indicator/category block 303. The time-frequency synchronization errors that degrade the performance of OFDM waveforms may be represented by their statistical behavior. The statistical information may comprise (but are not limited to) the distribution and the values of the moments of the time/frequency synchronization errors, i.e. TSE/carrier frequency offset (CFO), or the residual time/frequency synchronization errors in the case of (partial) compensation of those errors.

In step 301 of FIG. 3, the second transceiver device 130, e.g. the UE 130 may further share its position so that the first transceiver device 110, e.g. the BS 110 can estimate the separation distance 170 between the second transceiver device 130, e.g. the UE 130 and the first transceiver device 110, e.g. the BS 110 and may extract the channel statistics including the channel magnitude's statistics, path loss information and the delay spread. In an embodiment, the channel statistics that are extracted correspond to each CC allocated at a certain frequency with different CCB configuration. As illustrated in FIG. 3, the position information may be shared in a position block 305.

The first transceiver device 110, e.g. the BS 110 may then use this information to calculate the performance of a single CC through the calculation of the expected error vector magnitude (EVM) metric for each CCB that the second transceiver device 130, e.g. the UE 130 is capable to support. Based on the expected EVM performance, the expected CC data rate (CCDR) may be estimated for each CCB. Depending on the separation distance 170 between the second transceiver device 130, e.g. the UE 130 and the first transceiver device 110, e.g. the BS 110, the number of CCs, the CCB and their frequency locations may be extracted. Through carrier aggregation at the first transceiver device 110, e.g. the BS 110, the CC setup, i.e. the adaptive communication configuration 140, may be selected such that the overall data rate, also referred to as the expected aggregate data rate (ADR), is maximized.

In step 307 of FIG. 3, the CC setup, i.e. the adaptive communication configuration (referred to as block [symbol] ₒ in FIG. 3) 140, is sent from the first transceiver device 110, e.g. the BS 110 to the second transceiver device, e.g. the UE 130.

The second transceiver device 130, e.g. the UE 130 may also map the performance indicator metrics to a device category, in particular a UE category. Specifically, the performance indicators that are mapped to a UE category may be the second order statistics of the time and frequency synchronization errors (TSE and CFO) and UE AWGN levels. The UE 130 may signal its category using a UE Capability Information Message (CIM) to the BS 110 during RRC connection establishment procedure.

The calculation of the expected EVM, expected CCDR and expected ADR may allow the communication system 100 to avoid the exploration of all possible combinations to maximize the data rate based on the instantaneous performance at the UE's receiver, i.e. the communication interface 133 of the UE 130, and hence may also prevent signaling overhead between the BS 110 and the UE 130. Otherwise, the alternative may be to estimate the TSE and CFO at the UE 130 at each time, and send the updated estimates from the UE 130 to the BS 110 whenever there is a change in these estimates and use them to calculate the EVM, CCDR and finally the ADR.

In step 309 of FIG. 3, after sending the CC setup, i.e. the adaptive communication configuration 140, from the first transceiver device 110, e.g. the BS 110 to the second transceiver device 130, e.g. the UE 130, a communication is accordingly established.

In steps 311 to 315 of FIG. 3, the process of steps 301, 307 and 309 of FIG. 3 is repeated once the second transceiver device 130, e.g. the UE 130 changes location, and a new CC setup, i.e. the adaptive communication configuration 140, is selected to maximize the data rate. As illustrated in FIG. 3, the performance indicator/category block 303 may not be transmitted again in the repeated step 311.

In the following two main embodiments are described for determining the number of OFDM CCs, OFDM CCB and the carrier frequencies of the OFDM CCs an embodiment of the first transceiver device 110, e.g. the BS 110 operating in the 100 GHz-10 THz band. As will be described in more detail in the following, in the first main embodiment, this task is separated into a CC processing procedure and an ADR maximization procedure. These two procedures can be separated assuming identical channel statistics per CC. The second main embodiment works for different channel statistics per CC.

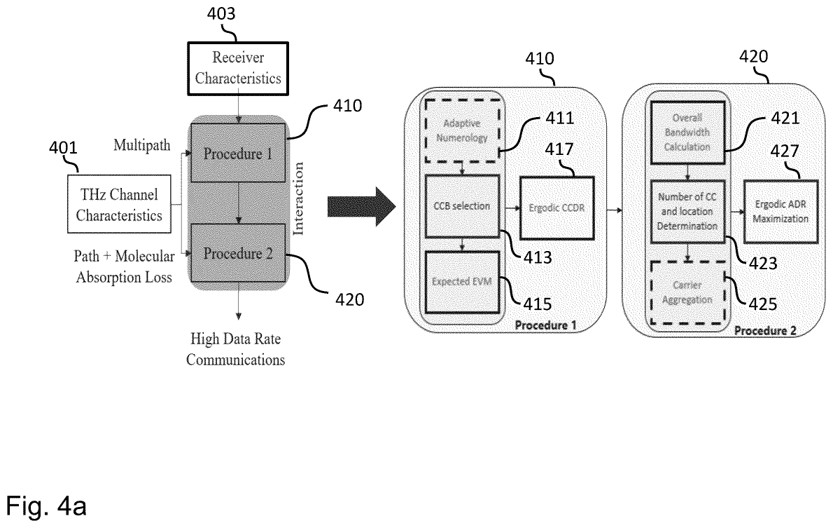

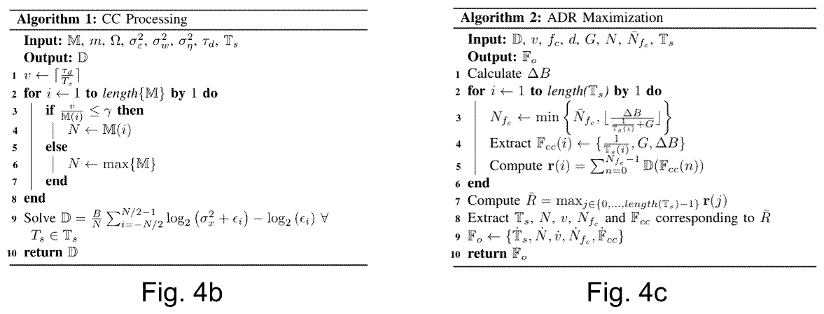

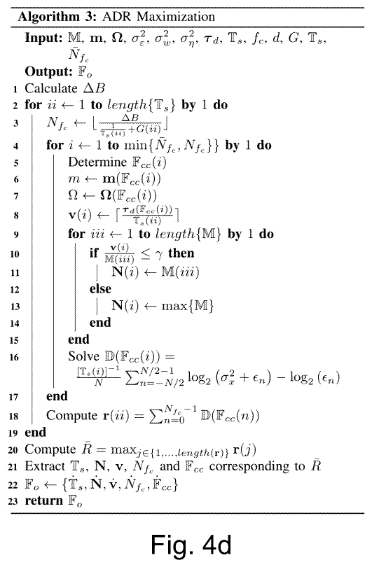

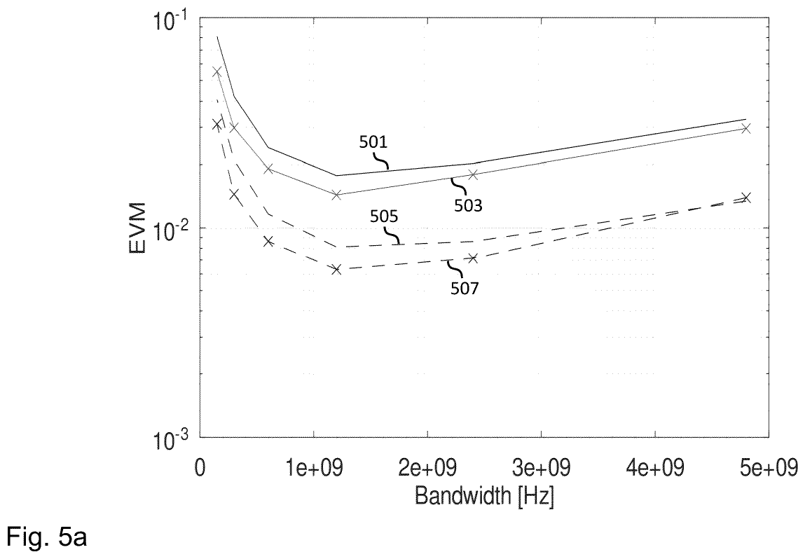

FIG. 4a shows a block diagram illustrating a first procedure 410 defined by a first algorithm and a second procedure 420 defined by a second algorithm implemented by the first transceiver device 110 according to the first main embodiment. An exemplary pseudo code of the first algorithm is shown in FIG. 4b (referred to as CC Processing algorithm in FIG. 4b) and an exemplary pseudo code of the second algorithm is shown in FIG. 4c (referred to as ADR Maximization algorithm in FIG. 4c).

As already mentioned above, the first procedure 410 and the second procedure 420 are configured to determine the number of OFDM CCs, OFDM CCB and the carrier frequencies of the OFDM CCs for THz communications systems, i.e., systems operating in 100 GHz-10 THz band.

As illustrated in FIG. 4a, the overall procedure may be divided into two parts. The first part realized by the first procedure 410 may deal with processing each CC by leveraging adaptive numerology to combat the performance degradations caused by CFO and TSE for each CCB. Adaptive numerology may be used to change the CCB, and the corresponding CCDR hence changes. Then, in the second part realized by the second procedure 420 the overall bandwidth may be calculated and all the combinations of the CCBs may be explored, which will yield different numbers of carrier components and after aggregation, different corresponding ADRs, where the CC setup, i.e. the adaptive communication configuration 140, that maximizes the ADR may be selected. As already mentioned above, for this first main embodiment, it is assumed that the channel statistics are identical for all CCs. This assumption may be adopted if the bandwidth ΔB is concise and contiguous, rendering the center frequencies of the CCs allocated to the bandwidth ΔB relatively close to the center frequency f_{c} of this bandwidth.

In the following, the first procedure 410 and the second procedure 420 implemented by the first transceiver device 110 according to the first main embodiment are described in more detail. The overall procedure may be based on THz channel characteristics or statistics 401. As described above for step 301 of FIG. 3, the overall procedure may be further based on the receiver characteristics or statistics 403, i.e. the capabilities of the receiver, i.e. the UE 130.

The first procedure 410 described above, i.e. the selection of CCB and the calculation of CCDR, may be realized by the first algorithm. As further illustrated in FIG. 4b, the first algorithm may take as input:
[symbol] and [symbol] ₛ, which denote the set of available FFT sizes N and the available sampling time values Tₛ, respectively;
channel statistics 401, including the delay spread τ_{d}, m, and Ω, where m represents the Nakagami-m shape parameter, and Ω is its spread parameter. Here, each channel tap may be distributed according to the Nakgami-m distribution in order to allow more flexibility for the statistical modeling for each of the channel taps at THz frequencies; and
statistics 403 of the time and frequency synchronization errors of the receiver performance, i.e. the performance of the UE 130, including variances of time and frequency synchronization errors

$${σ}_{ε}^{2} , {σ}_{η}^{2} ,$$

the AWGN variance

$${σ}_{w}^{2} .$$

Here, CFO and TSE may be considered to be zero-mean Gaussian random variables with variances

$${σ}_{ε}^{2} , {σ}_{η}^{2} ,$$

respectively.

As illustrated by boxes 411 and 413 of FIG. 4a, using this information, the first algorithm may process a single CC and results with a set of performance indicators corresponding to the available OFDM numerologies. In particular, after ensuring that the selected CP size meets a certain OFDM symbol efficiency requirement in terms of the ratio of the CP length to useful OFDM symbol length, the CCB may be varied while fixing the FFT size. Consequently, a trade-off can be observed when varying the sub-carrier spacing f_{scs}. More specifically, to combat frequency synchronization errors (CFO), a larger f_{scs} may be needed, which for a fixed FFT size results in a larger CCB. Then, increasing the CCB may result in higher errors due to TSE. Hence, there may be an optimum choice of sub-carrier spacing for a given TSE/CFO pair.

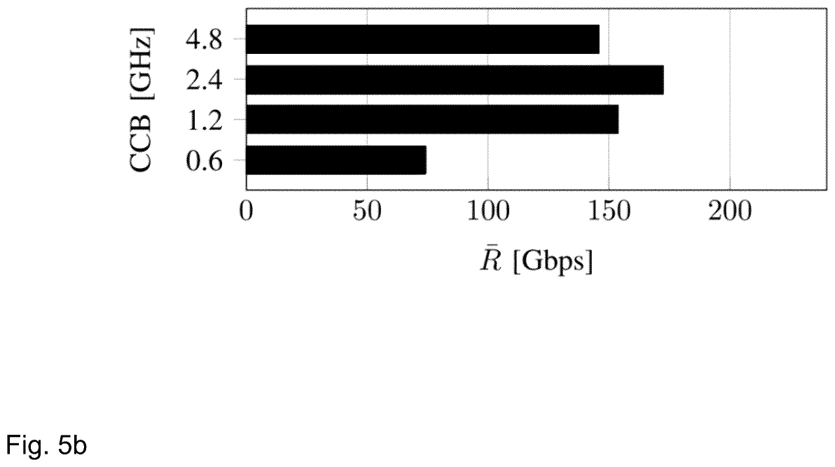

To illustrate this trade-off, FIG. 5a shows a graph illustrating the error vector magnitude (EVM) versus the selected bandwidth for two error setups. In FIG. 5a, an analytical result of the first error setup is shown by curve 501 and a simulation result of the first error setup is shown by curve 503. Moreover, an analytical result of the second error setup is shown by curve 505 and a simulation result of the second error setup is shown by curve 507.

As illustrated in FIG. 5a, the first error setup indicates poor time-frequency synchronization, and the second error setup indicates better time-frequency synchronization of a CC (single OFDM waveform). I.e., each error setup represents two TSE/CFO error pairs. The analytical and simulation results verify the accuracy of the analytical solution. As illustrated by boxes 415 and 417 of FIG. 4a, the result of the analytical evaluation of the expected EVM may be used in the calculation of the CCDR in the first algorithm. The behavior of the EVM as a function of the adopted CCB reveals the performance trade-off between selecting a small or large bandwidth for given time-frequency synchronization errors.

As further illustrated in FIG. 4b, to regulate the overall OFDM symbol efficiency, the loop starting from line 2 of FIG. 4b in the first algorithm may adjust the FFT size while ensuring that v/N≤γ, where γ is a threshold on the OFDM symbol efficiency and v is the cyclic prefix length in samples. A necessary exit condition in line 6 of the first algorithm of FIG. 4b may be set to ensure that the scheme is not locked in by the condition in line 3 of the first algorithm of FIG. 4b, which, if this case is reached, can compromise efficiency. After selecting the appropriate FFT size, the CCDRs may be calculated using the analytical EVM (∈) and the Tx power

$$( {σ}_{x}^{2} )$$

result for each CCD, and then the first algorithm may return a set [symbol] corresponding to the CCDRs that may be used in the second algorithm.

The second procedure 420 described above, i.e. the CC aggregation and ADR maximization, may be realized by the second algorithm. As further illustrated in FIG. 4c, the second algorithm may take as input:
(i) the CCDRs output [symbol] from the first algorithm;
(ii) the separation distance (d) 170 between the transmitter and the receiver,
(iii) the guard-band bandwidth G which defines the minimum separation between adjacent CCs in order to avoid interference, which is provided at the processing stage by the BS 110,
(iv) the FFT size N,
(v) the carrier center frequency f_{c} for the whole band,
(vi) [symbol] ₛ and
(vii) the maximum number N̅_{f}_{_{c}} of CCs that can be supported by both devices.

As illustrated by box 421 of FIG. 4a, using this information, the second algorithm may start with determining the available frequency range, i.e. overall available bandwidth ΔB, that depends on the separation distance d 170 between the transmitter, i.e. the first transceiver device 110, and the receiver, i.e. the second transceiver device 130. The overall available bandwidth ΔB is further illustrated in FIG. 2a. Here, ΔB corresponds to the available bandwidth between the two path loss peaks.

As illustrated by box 423 of FIG. 4a and as further illustrated in FIG. 4c, next, for each bandwidth setup, as written in line 3 of FIG. 4c, the number of CCs may be determined given ΔB and G. In the next line of FIG. 4c, as further illustrated by box 425 of FIG. 4a, the carrier frequency of each CC may be computed and inserted into the set [symbol] _{cc} given the available bandwidth, G and ΔB. In particular, in line 5 of FIG. 4c, the ADR may be calculated for each bandwidth setup at each assigned carrier frequency and stored in r, and after completion, as illustrated by box 427 of FIG. 4a, R̅ may capture the CCB and set [symbol] ₒ where the ADR is maximized. As an example, suppose that ΔB=25 GHz, G=4.8 GHz, f_{c}=342 GHz, N_{f}_{_{c}}=3, CCB=4.8 GHz. Then, the set of carrier frequencies is [symbol] _{cc}={332.4, 342, 351.6}×10⁹ Hz. In line 8 of the second algorithm of FIG. 4c, the arguments corresponding to the maximum achievable ADR are extracted, then in line 9 of FIG. 4c, the set [symbol] ₒ may return the number of CCs, i.e. N_{f}_{_{c}}, their corresponding CCBs, i.e. [symbol] ₛ, the set of their carrier frequencies, i.e. [symbol] _{cc}, the calculated CP length v and the (common) FFT size N to establish the CC setup, i.e. the adaptive communication configuration 140, between the UE 130 and the BS 110 and initiate the communications.

As already described above, the second main embodiment differs from the first main embodiment primarily in that different channel statistics per CC are considered and taken into account for the ADR maximization scheme defined by the third algorithm illustrated in FIG. 4d, which may be implemented by the first transceiver device 110 according to an embodiment for determining the number of OFDM CCs, OFDM CCB and the carrier frequencies of the OFDM CCs.

The third algorithm shown in FIG. 4d takes as input:
[symbol] and [symbol] ₛ, which denote the set of available FFT sizes N and the available sampling time values Tₛ, respectively,
the channel statistics including the delay spread τ_{d}, m, and Ω, which all depend now on the location of the CC in the available frequency spectrum,
the statistics of the receiver performance, including variances of time and frequency synchronization errors

$${σ}_{ε}^{2} , {σ}_{η}^{2} ,$$

the AWGN variance

$${σ}_{w}^{2} ,$$

the separation distance d between the transmitter and the receiver,
the guard-band bandwidth G, which defines the separation between adjacent CCs in order to avoid interference,
the carrier center frequency f_{c} for the whole band, where the CC are planned to be distributed, and
the maximum number of CCs N̅_{f}_{_{c}} that can be supported.

Based on these inputs the third algorithm shown in FIG. 4d starts by calculating the available bandwidth ΔB as an initial step to distribute the CCs while being aware of the distance dependent molecular absorption loss peaks. Then, for each CCB, the number of CCs is calculated as per the calculation performed in line 3 of the third algorithm shown in FIG. 4d. In line 5 of the third algorithm shown in FIG. 4d, the individual CC center frequency [symbol] _{cc}(i) is determined. Subsequently, the channel statistics that are necessary for the calculation of the EVM are extracted depending on [symbol] _{cc}(i), and the CP length is calculated based on the delay spread identified at each [symbol] _{cc}(i). To regulate the overall OFDM symbol efficiency, the loop starting from line 10 of the third algorithm shown in FIG. 4d adjusts the FFT size (N) for each CC while ensuring that the ratio between the CP length at each CC (v(i)) and the FFT size ( [symbol] (iii)) is less than γ, where γ is a threshold on the OFDM symbol efficiency. A necessary exit condition in line 13 of the third algorithm shown in FIG. 4d is set to ensure that the scheme is not blocked by the condition in line 11 of the third algorithm shown in FIG. 4d, while noting that if this case is reached, efficiency is compromised. After selecting the appropriate FFT size, the CCDR is calculated for each CC using the expected EVM for each CCB, and then a set D is returned, corresponding to the CCDRs for each CC. Through carrier aggregation, the CCDR is then used to calculate the ADR, as indicated in line 18 of the third algorithm shown in FIG. 4d for each CCB setup. In line 20 of the third algorithm shown in FIG. 4d, the maximum ADR is found, and the CCB, set of FFT sizes for each CC \dot{N}, set of CP lengths containing the CP length for each CC \dot{v}, the number of CCs \dot{N}_{f}_{_{c}} and their locations [symbol] _{cc}, the best sampling time [symbol] ₛ corresponding to the maximum ADR are identified, where each of these quantities is associated with the set [symbol] ₒ that for establishing the communication session, as illustrated in FIG. 3.

To illustrate the effectiveness of the proposed scheme, the results shown in FIG. 5b illustrate that for each CCB, a different ADR is achieved, where the CCB to be selected is the one corresponding to 2.4 GHz, since it yields the highest achievable ADR of around 172 Gbps. For the CCB of 0.6 GHZ, the performance limitation is attributed to the limitation of the maximum number of CCs that could be aggregated, which in this exemplary embodiment, is set equal to 16. Note that to generate this set of results, identical channel statistics were assumed to be observed by all CCs.

Embodiments disclosed herein may efficiently utilize the radio resources in a wireless communications system 100 with large available bandwidth considering the following practical limitations: (i) dependence of the available bandwidth on the separation distance 170 between the transmitter, i.e. the first transceiver device 110, and the receiver, i.e. the second transceiver device 130, due to frequency selective path loss, and (ii) the receiver's performance depending on the statistics of time and frequency synchronization errors.

Advantageously, embodiments disclosed herein may maximize the data rate while considering the aforementioned limitations. In particular, for achieving this, two technologies may be combined: (i) using adaptive OFDM numerology to vary the bandwidth of a single CC, and (ii) using component carrier aggregation to utilize the large chunks of available bandwidth.

Advantageously, instead of for example deploying a single OFDM waveform that tightens the synchronization constraints in the case of high bandwidths (large FFT sizes), embodiments disclosed herein may divide the available frequency spectrum into sub-bands such that a CC can occupy the bandwidth of each sub-band (CCB), and then aggregate all the carrier in the aim of maximizing the data rate. Moreover, through adaptive OFDM numerology, each CCB may be varied to combat the intrinsic time-frequency synchronization errors at the receiver, i.e. the second transceiver device 130, captured by the statistics that are reported by the UE 130 to the BS 110.

Moreover, embodiments disclosed herein may deploy OFDM to combat frequency selectivity imposed by the channel at each CC. In traditional approaches, the channel's coherence bandwidth may be the only metric that determines the CCB. In embodiments disclosed herein, the CCB may be no more limited by the coherence bandwidth, and through the use of a multicarrier waveform such as OFDM, frequency selectivity for each CC can be combated, and higher CCB can be achieved. As OFDM may be sensitive to synchronization errors, embodiments disclosed herein may utilizes adaptive numerology as an additional degree of freedom to combat the detrimental effects of synchronization errors and vary the CCB. Hence, the problem of finding the CC setup, i.e. the adaptive communication configuration 140, which includes the number and bandwidth of the CCs that maximizes the ADR given the synchronization constraints and different separation distance between the communicating nodes, is solved.

Moreover, with adaptive OFDM numerology and carrier aggregation, embodiments disclosed herein may make use of all of the available bandwidth through allocating several CCs at different frequencies. In other words, spectral partitioning may be performed adaptively depending on the separation distance between the transmitter, i.e. the first transceiver device 110, and the receiver, i.e. the second transceiver device 130. Thus, using several CCs may allow for exploiting the full available spectrum and may increase the overall data rate.

As already described above, embodiments disclosed herein are not limited to OFDM signal waveforms and can be applied to other types of waveforms.

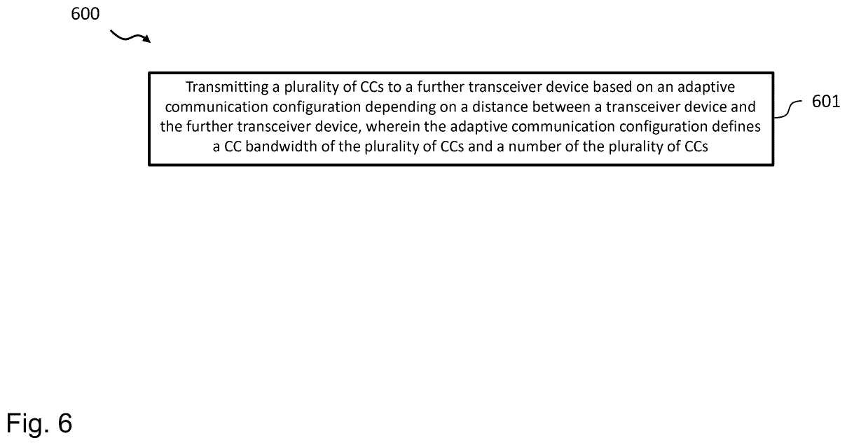

FIG. 6 shows a flow diagram illustrating a method 600 according to an embodiment for wireless communication using carrier aggregation of a plurality of component carriers, CCs, distributed over an available bandwidth in an operational frequency range, each CC carrying a respective signal waveform.

The method 600 comprises a step 601 of transmitting the plurality of CCs to the first transceiver device 110 based on the adaptive communication configuration 140 depending on the distance 170 between the second transceiver device 130 and the first transceiver device 110, wherein the adaptive communication configuration 140 defines a CC bandwidth of the plurality of CCs and a number of the plurality of CCs.

As the method 600 can be implemented by the second transceiver device 130, further features of the method 600 result directly from the functionality of the the second transceiver device 130 and its different embodiments described above and below.

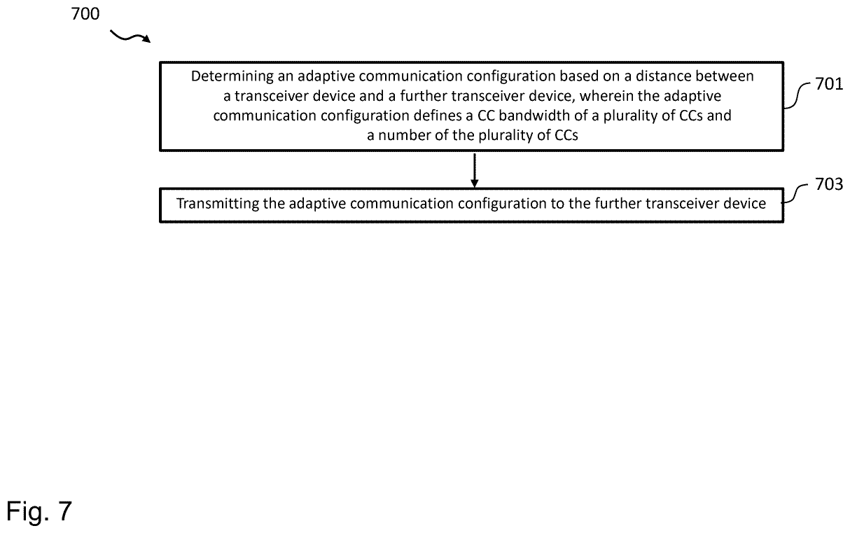

FIG. 7 shows a flow diagram illustrating a method 700 according to an embodiment for wireless communication using carrier aggregation of a plurality of component carriers, CCs, distributed over an available bandwidth in an operational frequency range, each CC carrying a respective signal waveform.

The method 700 comprises a step 701 of determining an adaptive communication configuration 140 based on a distance 170 between the first transceiver device 110 and the second transceiver device 130, wherein the adaptive communication configuration 140 defines a CC bandwidth of the plurality of CCs and a number of the plurality of CCs.

The method 700 further comprises a step 703 of transmitting the adaptive communication configuration 140 to the second transceiver device 130 for transmission of the plurality of CCs by the second transceiver device 130 to the first transceiver device 110 based on the adaptive communication configuration 140.

As the method 700 can be implemented by the first transceiver device 110, further features of the method 700 result directly from the functionality of the first transceiver device 110 and its different embodiments described above and below.

The person skilled in the art will understand that the “blocks” (“units”) of the various figures (method and apparatus) represent or describe functionalities of embodiments of the present disclosure (rather than necessarily individual “units” in hardware or software) and thus describe equally functions or features of apparatus embodiments as well as method embodiments (unit=step).

In the several embodiments provided in the present application, it should be understood that the disclosed system, apparatus, and method may be implemented in other manners. For example, the described embodiment of an apparatus is merely exemplary. For example, the unit division is merely logical function division and may be another division in an actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments of the disclosure may be integrated into one processing unit, or each of the units may exist alone physically, or two or more units are integrated into one unit.

1. A transceiver device for wireless communication using carrier aggregation of a plurality of component carriers (CCs) distributed over an available bandwidth in an operational frequency range, each CC carrying a signal waveform, wherein the transceiver device comprises:
a communication interface configured to transmit the plurality of CCs to a further transceiver device based on an adaptive communication configuration depending on a distance between the transceiver device and the further transceiver device, wherein the adaptive communication configuration defines a CC bandwidth of the plurality of CCs and a number of the plurality of CCs.

2. The transceiver device of claim 1, wherein the adaptive communication configuration further defines for each of the plurality of CCs a central CC frequency.

3. The transceiver device of claim 1, wherein the communication interface is configured to transmit the plurality of CCs such that a respective guard band is arranged between adjacent CCs of the plurality of CCs.

4. The transceiver device of claim 3, wherein the adaptive communication configuration defines a bandwidth of a plurality of guard bands that are located between adjacent CCs.

5. The transceiver device of claim 1, wherein the transceiver device further comprises a processing circuitry configured to determine the adaptive communication configuration based on an estimate of the distance between the transceiver device and the further transceiver device.

6. The transceiver device of claim 5, wherein the signal waveform is a multi-carrier signal waveform.

7. The transceiver device of claim 5, wherein the processing circuitry is further configured to determine the adaptive communication configuration based on the distance between the transceiver device and the further transceiver device and based on information about the communication channel between the transceiver device and the further transceiver device and/or information about a time and frequency synchronisation performance of the transceiver device.

8. The transceiver device of claim 5, wherein the processing circuitry is further configured to implement a path loss model configured to provide a path loss estimate for a plurality of frequencies in the operational frequency range and for a plurality of distances between the transceiver device and the further transceiver device and wherein the processing circuitry is further configured to determine the adaptive communication configuration using the path loss model.

9. The transceiver device of claim 5, wherein the processing circuitry is configured to determine the adaptive communication configuration by maximizing a communication data rate for a plurality of candidate communication configurations.

10. The transceiver device of claim 1, wherein the communication interface is configured to receive the adaptive communication configuration from the further transceiver device.

11. A method for wireless communication using carrier aggregation of a plurality of component carriers (CCs) distributed over an available bandwidth in an operational frequency range, each CC carrying a signal waveform, wherein the method comprises:
transmitting the plurality of CCs to a further transceiver device based on an adaptive communication configuration depending on a distance between a transceiver device and the further transceiver device, wherein the adaptive communication configuration defines a CC bandwidth of the plurality of CCs and a number of the plurality of CCs.

12. The method of claim 11, wherein the adaptive communication configuration further defines for each of the plurality of CCs a central CC frequency.

13. The method of claim 11, wherein the transmitting the plurality of CCs comprising: transmitting the plurality of CCs such that a respective guard band is arranged between adjacent CCs of the plurality of CCs.

14. The method of claim 13, wherein the adaptive communication configuration defines a bandwidth of a plurality of guard bands that are located between adjacent CCs.

15. The method of claim 11, wherein the method further comprises: determining the adaptive communication configuration based on an estimate of the distance between the transceiver device and the further transceiver device.

16. The method of claim 15, wherein the signal waveform is a multi-carrier signal waveform.

17. The method of claim 15, wherein the method further comprises: determining the adaptive communication configuration based on the distance between the transceiver device and the further transceiver device and based on information about the communication channel between the transceiver device and the further transceiver device and/or information about a time and frequency synchronisation performance of the transceiver device.

18. The method of claim 15, wherein the method further comprises: implementing a path loss model configured to provide a path loss estimate for a plurality of frequencies in the operational frequency range and for a plurality of distances between the transceiver device and the further transceiver device; and determining the adaptive communication configuration using the path loss model.

19. The method of claim 15, wherein the method further comprises: determining the adaptive communication configuration by maximizing a communication data rate for a plurality of candidate communication configurations.

20. The method of claim 11, wherein the method further comprises: receiving the adaptive communication configuration from the further transceiver device.
